(19) United States
(12) Patent Application Publication
(10) Pub. No.: US 2023/0080291 A1
(43) Pub. Date: Mar. 16, 2023

(54) AUTOMATIC BALL LAUNCHER

(71) Applicant: Jian Zhang, Shanghai (CN)

(72) Inventor: Xudong Ding, Ningbo (CN)

(21) Appl. No.: 18/057,727

(22) Filed: Nov. 21, 2022

(51) Int. Cl. A63B 69/40

(52) U.S. Cl. CPC A63B 69/406; A01K 15/025

(57) ABSTRACT

The utility model discloses an automatic ball launcher. The automatic ball launcher includes a ball launcher shell, in which an accommodating space is arranged; a ball launching channel, arranged in the accommodating space and provided with a ball launching inlet and a ball launching outlet; an acceleration mechanism, arranged in the accommodating space for pushing and accelerating the ball that enters the ball launching channel to a preset speed; and a ball launching mechanism, arranged in the accommodating space and close to the ball launching outlet for receiving the ball that is pushed by the acceleration mechanism and launching the ball from the ball launching outlet to the outside of the ball launching channel. The utility model can launch the ball more stably.

### TECHNICAL FIELD

The utility model relates to the technical field of pet products, in particular to an automatic ball launcher.

### BACKGROUND

In recent years, with the improvement of people's living standard, more and more citizens began to keep pets. Accordingly, various pet products have emerged.

An automatic ball launcher is a new pet product. The automatic ball launcher launches a ball for dogs to chase and play with the ball. The existing automatic ball launcher puts a ball into a ball launcher, and the ball is conveyed to a ball launching mechanism by a conveying device. The ball launching mechanism includes two wheels rotating at high speed. The ball is launched while the wheels rotate at high speed. However, the moving speed of the ball is low, and launching of the ball conveyed by the conveying device needs to be driven by the wheels to accelerate. Therefore, the wheels vibrate because of large force applied on the wheels in the launching process, resulting in unstable launching and excessive noise.

### SUMMARY

The utility model provides an automatic ball launcher, which may more stably launch a ball.

To resolve the technical problem above, the utility model discloses an automatic ball launcher, which includes:

a ball launcher shell, in which an accommodating space is arranged;

a ball launching channel, which is arranged in the accommodating space and provided with a ball launching inlet and a ball launching outlet;

an acceleration mechanism, which is arranged in the accommodating space for pushing and accelerating the ball that enters the ball launching channel to a preset speed; and

a ball launching mechanism, which is arranged in the accommodating space and close to the ball launching outlet for receiving the ball that is pushed by the acceleration mechanism and launching the ball from the ball launching outlet to the outside of the ball launching channel.

Preferably, the acceleration mechanism includes: a pushing driving component, a movable part pushing component, and a ball driving component. The movable part pushing component is movably arranged inside the accommodating space, and the movable part pushing component moves relative to the ball launcher shell. The pushing driving component is connected with the movable part pushing component and configured to drive the movable part pushing component to move. The ball driving component is connected with the movable part pushing component, and the ball driving component extends into the ball launching channel to contact the ball.

Preferably, the movable part pushing component is a rack, the pushing driving component is a pushing driving motor, and the pushing driving motor is connected with the rack through a gear.

Preferably, the acceleration mechanism further includes a pushing shell, a sliding track is arranged on the pushing shell, and the movable part pushing component is movably connected with the sliding track.

Preferably, the sliding track is a sliding groove, guide posts are arranged at both ends of the rack, and the guide posts are movably arranged in the sliding groove.

Preferably, the ball launching mechanism includes two rotating wheels, the rotating wheels are connected with a ball launching motor, and the rotating wheels extend into the ball launching channel.

Preferably, the ball launcher shell includes a channel shell. The ball launching channel is arranged in the channel shell. The ball launching channel includes a blanking channel, a pushing channel, and a launching channel. A first end of the blanking channel is the ball launching inlet, a second end of the blanking channel is connected with the pushing channel, a first end of the launching channel is the ball launching outlet, a second end of the launching channel is connected with the pushing channel; and the blanking channel is a vertical channel, and the launching channel obliquely extends upward.

Preferably, a mounting part is arranged on the channel shell and on both sides of the pushing channel, and the mounting part is a plate body extending outward.

Preferably, an external extending part is arranged on the channel shell and in the position of the blanking channel.

Preferably, the ball launcher shell includes a blanking disc body, and the blanking disc body is located at the ball launching inlet.

The automatic ball launcher provided by the utility model is provided with the ball launching channel, and the ball enters the ball launching channel from the ball launching inlet of the ball launching channel. After entering the ball launching channel, the ball is first pushed by the acceleration mechanism, to be accelerated to the preset speed in the pushing process, and then the ball launching mechanism launches the ball with the preset. Because the ball is accelerated by the acceleration mechanism, and launched by the ball launching mechanism, a ball launching force applied on the ball launching mechanism is small, so that the ball may be more stably launched, without larger vibration. In addition, noise produced in the ball launching process may be reduced.

The foregoing description is only an overview of the technical proposal. To more clearly understand the technical means of the utility model, the utility model may be implemented in accordance with the content of the specification. To more clearly understood the above and other purposes, characteristics, and advantages of the utility model, the specific embodiments of the utility model are described below.

### BRIEF DESCRIPTION OF THE DRAWINGS

FIG. 1 is a schematic diagram of the appearance of an automatic ball launcher according to an embodiment of the utility model;

FIG. 2 is a schematic diagram of the inner structure of an automatic ball launcher according to an embodiment of the utility model;

FIG. 3 is a schematic diagram of the ball launching channel according to an embodiment of the utility model;

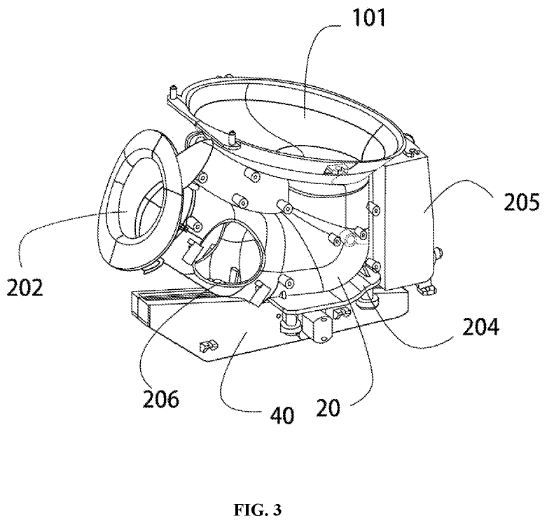

FIG. 4 is a schematic diagram of the ball launching channel according to an embodiment of the utility model;

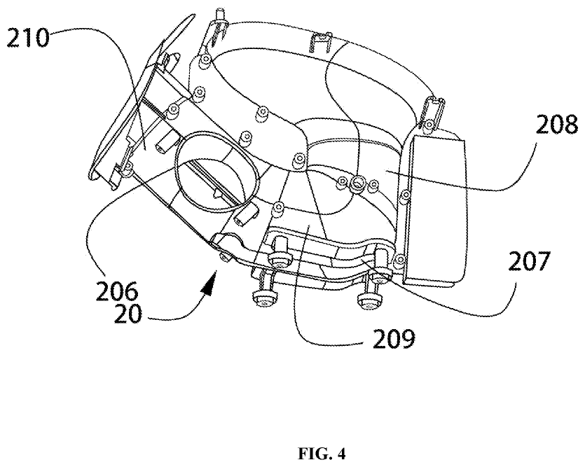

FIG. 5 is a schematic diagram of the acceleration mechanism according to an embodiment of the utility model; and

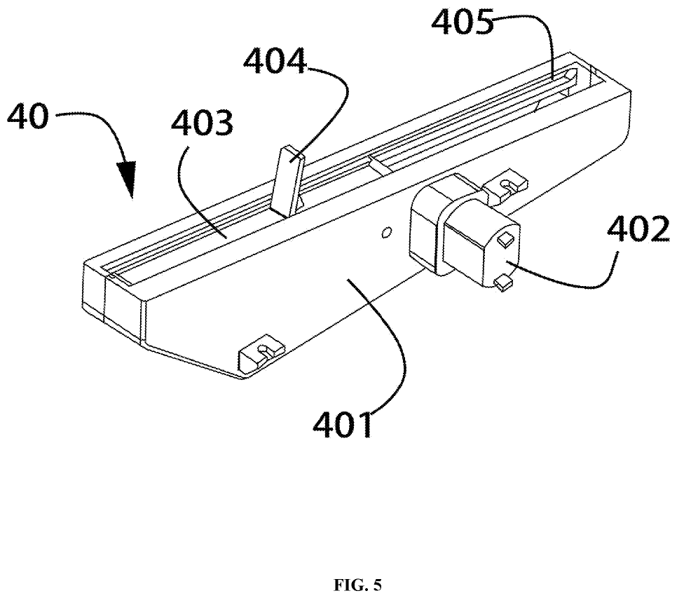

FIG. 6 is a schematic diagram of the acceleration mechanism according to an embodiment of the utility model.

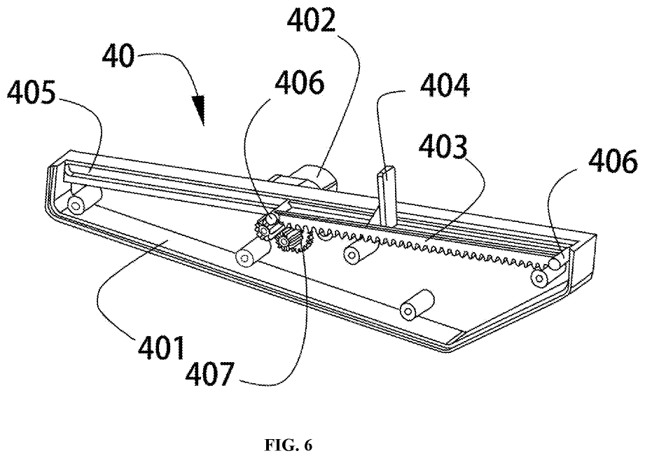

In the figures: 10. ball launcher shell; 20. channel shell; 30. ball launching mechanism; 40. acceleration mechanism; 101. arc surface; 102. blanking disc; 103. bottom of shell; 104. battery compartment; 201. ball launching inlet; 202. ball launching outlet; 203. ball launching channel; 204. mounting part; 205. external extending part; 206. through hole; 207. through groove; 208. blanking channel; 209. pushing channel; 210. launching channel; 301. ball launching bracket; 302. ball launching motor; 303. rotating wheels; 401. pushing shell; 402. pushing driving component; 403. movable part pushing component; 404. ball driving component; 405. sliding track; 406. guide posts; and 407. gear.

### DETAILED DESCRIPTION OF EMBODIMENTS

To more obviously and easily understand the purposes, characteristics, and advantages of the utility model, the technical proposals in embodiments of the utility model will be described clearly and completely in the following, with reference to the accompanying drawings in embodiments of the utility model. Apparently, the embodiments described are only a part of the embodiments of the utility model, not all embodiments. All other embodiments obtained by those skilled in the art based on embodiments of the utility model without creative efforts fall within the scope of protection of the utility model.

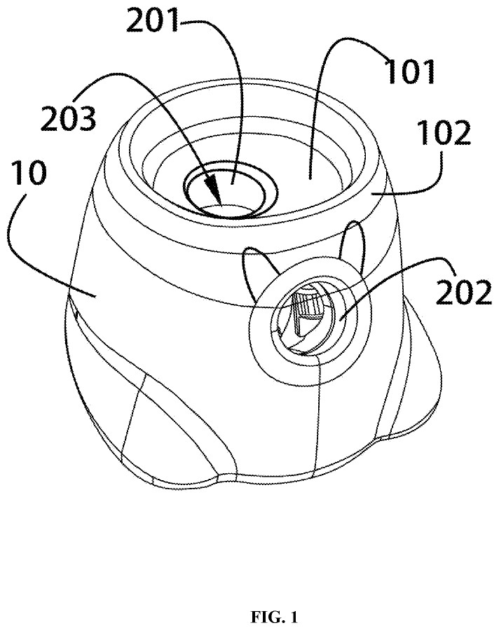

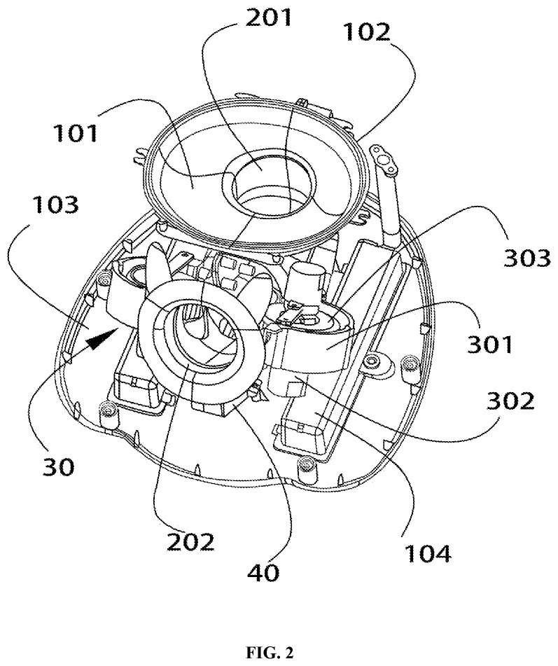

Refer to FIG. 1 to FIG. 2. The utility model discloses an automatic ball launcher, which includes:

a ball launcher shell 10, in which an accommodating space is arranged;

a ball launching channel 203, arranged in the accommodating space and provided with a ball launching inlet 201 and a ball launching outlet 202;

an acceleration mechanism 40, arranged in the accommodating space for pushing and accelerating the ball that enters the ball launching channel 203 to a preset speed; and

a ball launching mechanism 30, arranged in the accommodating space and close to the ball launching outlet 202 for receiving the ball that is pushed by the acceleration mechanism 40 and launching the ball from the ball launching outlet 202 to the outside of the ball launching channel 203.

The automatic ball launcher provided by the utility model is provided with the ball launching channel 203, and the ball enters the ball launching channel 203 from the ball launching inlet 201 of the ball launching channel 203. After entering the ball launching channel 203, the ball is first pushed by the acceleration mechanism 40, to be accelerated to the preset speed in the pushing process, and then the ball launching mechanism 30 launches the ball with the preset speed. Because the ball is accelerated by the acceleration mechanism 40, and launched by the ball launching mechanism 30, the ball launching force applied on the ball launching mechanism is small, so that the ball may be more stably launched, without larger vibration. In addition, noise produced in the ball launching process may be reduced.

Specifically, according to the utility model, a ball sensor may be arranged in the ball launching channel 203 to sense the ball entering the ball launching channel 203. This may be realized by various sensing sensors. When the ball is sensed to enter the ball launching channel 203, the acceleration mechanism 40 and the ball launching mechanism 30 are started to work.

In a further implementation of this embodiment, the acceleration mechanism 40 includes a pushing driving component 402, a movable part pushing component 403, and a ball driving component 404. The movable part pushing component 403 is movably arranged inside the accommodating space, and the movable part pushing component 403 may move relative to the ball launcher shell 10. The pushing driving component 402 is connected with the movable part pushing component 403 and configured to drive the movable part pushing component 403 to move. The ball driving component 404 is connected with the movable part pushing component, and the ball driving component 404 extends into the ball launching channel to contact the ball.

In this embodiment, the ball driving component 404 extends into the ball launching channel 203. When the ball enters the ball launching channel 203, the ball driving component 404 comes into contact with the ball, and the movable part pushing component 403 is driven by the pushing driving component 402 to move. During movement, the ball driving component 404 is configured to push and accelerate the ball. The acceleration mechanism 40 in this embodiment has is simple in structure and convenient to operate.

In a further implementation of this embodiment, the movable part pushing component 403 is a rack, the pushing driving component 402 is a pushing driving motor, and the pushing driving motor is connected with the rack through a gear 407.

In this embodiment, the movable part pushing component 403 is a rack, and the pushing driving motor drives the gear 407 to rotate. While rotating, the gear 407 may drive the rack to move linearly. The whole pushing process is more stable through the fitting of the rack and the gear 407. In addition, the structure is simpler and more reasonable, and the pushing noise may be reduced at the same time.

In a further implementation of this embodiment, the acceleration mechanism 40 further includes a pushing shell 401, a sliding track 405 is arranged on the pushing shell 401, and the movable part pushing component 403 is connected with the sliding track 405.

In this embodiment, the sliding track 405 is arranged on the pushing shell 401, the movable part pushing component 403 slides along the sliding track 405, to enable the movable part pushing component 403 to more stably move.

In a further implementation of this embodiment, the sliding track 405 is a sliding groove, guide posts 406 are arranged at both ends of the rack, and the guide posts 406 are movably arranged in the sliding groove.

In this embodiment, the sliding groove is used as the sliding track 405, and the sliding groove limits the guide posts 406. Therefore, stability of movement is further improved.

Specifically, in this embodiment, the both ends of the guide posts 406 are arc-shaped. Therefore, friction may be reduced and sliding is smoother.

In this embodiment, when the acceleration mechanism 40 works, the movable part pushing component 403 is located at a first position, the ball mounted on the movable part pushing component 403 drives the component 404 to move to a position where is close to a rear end of the pushing shell 401. After the ball enters the ball launching channel 203, the ball driving component 404 is located behind the ball, and the pushing driving motor rotates to drive the rack to move forward to a second position. After the ball driving component 404 pushes the ball forward to accelerate the ball to the preset speed, the ball launching mechanism 30 launches the ball. The pushing driving motor rotates in the opposite direction to drive the rack to be restored from the second position to the first position.

In a further implementation of this embodiment, the ball launching mechanism 30 includes two rotating wheels 303. The rotating wheels 303 are connected with a ball launching motor 302, and the rotating wheels 303 extend into the ball launching channel 203.

In this embodiment, the ball launching mechanism 30 is simple in structure, and ball may be stably launched and conveniently controlled.

Specifically, in this embodiment, the ball launching mechanism 30 further includes a ball launching bracket 301. The rotating wheels 303 are rotationally mounted the ball launching bracket 301, and the two rotating wheels 303 extend into the ball launching channel 203 from the side close to the ball launching channel 203.

In a further implementation of this embodiment, the ball launcher shell 10 includes a channel shell 20. The ball launching channel 203 is arranged in the channel shell 20. The ball launching channel 203 includes a blanking channel 208, a pushing channel 209, and a launching channel 210. A first end of the blanking channel 208 is the ball launching inlet 201, a second end of the blanking channel 208 is connected with the pushing channel 209, a first end of the launching channel 210 is the ball launching outlet, a second end of the launching channel 210 is connected with the pushing channel 209. The blanking channel 208 is a vertical channel, and the launching channel 210 obliquely extends upward.

In this embodiment, the blanking channel 208 is a vertical channel, so that the ball may fall to the pushing channel 209 under the action of gravity. The launching channel 210 obliquely extends upward, so that the ball may be obliquely launched upward, and the ball may be conveniently launched out of the ball launching channel 203. In addition, in this embodiment, the connection of the pushing channel 209 also obliquely extends upward, and a slope of the pushing channel 209 is smaller than that of the launching channel 210, so that the acceleration mechanism 40 and the ball launching mechanism 30 may be conveniently connected.

Therefore, in this embodiment, the pushing shell 401 is correspondingly arranged to the pushing channel 209. Specifically, the top of the pushing shell 401 is inclined, the sliding groove is obliquely arranged, and the slope of the sliding groove corresponds to that of the pushing channel 209, so that the ball may be obliquely pushed to be accelerated, and may be matched with the ball launching mechanism 30 and the launching channel 210.

In addition, in this embodiment, the acceleration mechanism 40 is arranged at the bottom of the ball launching channel 203, the channel shell 20 is located at the position of the pushing channel 209 and is provided with a through groove 207 in a length direction thereof. The ball driving component 404 extends into the pushing channel 209 from the through groove 207. In this embodiment, the ball driving component 404 is a vertical plate, and the vertical plate is vertically fastened on the rack.

In this embodiment, parts of the channel shell 20 that are close to two sides of the ball launching channel 210 are provided with through holes 206, and the rotating wheels 303 extend into the launching channel 210 from the through holes 206.

The two rotating wheels 303 rotate in opposite directions during working, the accelerated ball is pushed between the two rotating wheels 303 and comes into contact with inner sides of the rotating wheels 303, and then the ball is thrown out while the rotating wheels 303 rotates at high speed.

In a further implementation of this embodiment, a mounting part 204 is arranged on the channel shell 20 and on both sides of the pushing channel 209, and the mounting part 204 is a plate body extending outward.

In this embodiment, the mounting part 204 facilitates a connection between the channel shell 20 and the ball launcher shell 10.

In a further implementation of this embodiment, an external extending part 205 is arranged on the channel shell 20 and in the position of the blanking channel 208.

In this embodiment, the external extending part 205 facilitates a connection between the channel shell 20 and the ball launcher shell 10.

In a further implementation of this embodiment, the ball launcher shell 10 includes a blanking disc body 102, and the blanking disc body 102 is located at the ball launching inlet 201.

In this embodiment, the inner side of the blanking disc body 102 is an arc-shaped surface 101, and the ball launching inlet 201 is arranged at the lowest part of the blanking disc body 102, so that the ball may conveniently enter the ball launching inlet 201.

In this embodiment, a battery compartment 104 is arranged at the bottom 103 of the shell. The battery compartment 104 is used to accommodate a battery. The battery is used to supplies power to various mechanical components and a control system.

In the descriptions of this specification, descriptions of reference terms such as “an embodiment”, “some embodiments”, “example”, “specific example”, or “some examples” mean that specific features, structures, materials, or characteristics described in connection with the embodiment or example are included in at least one embodiment or example of this utility model. In addition, the described specific features, structures, materials, or characteristics may be combined in a suitable manner in any one or more embodiments or examples. Further, a person skilled in the art may connect and combine different embodiments or examples described in this specification and features of different embodiments or examples without contradicting one another.

Furthermore, terms such as “first” and “second” are only used for descriptive purposes only, do not necessarily require or imply relative importance, or imply the number of indicated technical features. Thus, a feature defined with “first” and “second” may explicitly or implicitly include the at least one feature. In the descriptions of the utility model, unless otherwise specified, “multiple” means two or more.

The foregoing descriptions are only specific embodiments of the utility model, and are not used to limit the scope of protection of the utility model. In the technical scope disclosed in the utility model, changes or replacement that a person skilled in the art gets, all fall within the scope of protection of the utility model. Therefore, the scope of protection of the utility model should be subject to the scope of protection of the claims.

What is claimed is:

1. An automatic ball launcher, characterized by comprising:
a ball launcher shell, in which an accommodating space is arranged;
a ball launching channel, arranged in the accommodating space and provided with a ball launching inlet and a ball launching outlet;
an acceleration mechanism, arranged in the accommodating space for pushing and accelerating the ball that enters the ball launching channel to a preset speed; and
a ball launching mechanism, arranged in the accommodating space and close to the ball launching outlet for receiving the ball that is pushed by the acceleration mechanism and launching the ball from the ball launching outlet to the outside of the ball launching channel.

2. The automatic ball launcher according to claim 1, characterized in that the acceleration mechanism comprises a pushing driving component, a movable part pushing component, and a ball driving component; the movable part pushing component is movably arranged inside the accommodating space, the movable part pushing component moves relative to the ball launcher shell, the pushing driving component is connected with the movable part pushing component and configured to drive the movable part pushing component to move, the ball driving component is connected with the movable part pushing component, and the ball driving component extends into the ball launching channel to contact the ball.

3. The automatic ball launcher according to claim 2, characterized in that the movable part pushing component is a rack, the pushing driving component is a pushing driving motor, and the pushing driving motor is connected with the rack through a gear.

4. The automatic ball launcher according to claim 3, characterized in that the acceleration mechanism further comprises a pushing shell, a sliding track is arranged on the pushing shell, and the movable part pushing component is movably connected with the sliding track.

5. The automatic ball launcher according to claim 4, characterized in that the sliding track is a sliding groove, guide posts are arranged at both ends of the rack, and the guide posts are movably arranged in the sliding groove.

6. The automatic ball launcher according to claim 1, characterized in that the ball launching mechanism comprises two rotating wheels, the rotating wheels are connected with a ball launching motor, and the rotating wheels extend into the ball launching channel.

7. The automatic ball launcher according to claim 1, characterized in that the ball launcher shell comprises a channel shell; the ball launching channel is arranged in the channel shell; the ball launching channel comprises a blanking channel, a pushing channel, and a launching channel; a first end of the blanking channel is the ball launching inlet, a second end of the blanking channel is connected with the pushing channel, a first end of the launching channel is the ball launching outlet, a second end of the launching channel is connected with the pushing channel; and the blanking channel is a vertical channel, and the launching channel obliquely extends upward.

8. The automatic ball launcher according to claim 7, characterized in that a mounting part is arranged on the channel shell and on both sides of the pushing channel, and the mounting part is a plate body extending outward.

9. The automatic ball launcher according to claim 7, characterized in that an external extending part is arranged on the channel shell and in the position of the blanking channel.

10. The automatic ball launcher according to claim 1, characterized in that the ball launcher shell comprises a blanking disc body, and the blanking disc body is located at the ball launching inlet.
